(19) United States
(12) Patent Application Publication
(10) Pub. No.: US 2013/0180352 A1
(43) Pub. Date: Jul. 18, 2013

(54) COATED COGWHEEL

(71) Applicant: Siemens Aktiengesellschaft, Munchen (DE)

(72) Inventor: Jean-Andre Meis, Duelmen (DE)

(73) Assignee: Siemens Aktiengesellschaft, Munchen (DE)

(21) Appl. No.: 13/743,841

(22) Filed: Jan. 17, 2013

(30) Foreign Application Priority Data
Jan. 18, 2012 (EP) 12151603.3

(51) Int. Cl. F16H 55/06; B05D 5/00

(52) U.S. Cl. CPC F16H 55/06; B05D 5/00
USPC 74/434; 427/282; 427/555

(57) ABSTRACT

A coated cogwheel includes a cogwheel body made from a basis material. A layer which is harder than the basis material is arranged at least on a part of the cogwheel body, for example on the flanks of a tooth. The layer is subdivided by seams into a multiplicity of mutually separated segments.

### CROSS-REFERENCES TO RELATED APPLICATIONS

This application claims the priority of European Patent Application, Serial No. EP 12 15 1603, filed Jan. 18, 2012, pursuant to 35 U.S.C. 119(a)-(d), the content of which is incorporated herein by reference in its entirety as if fully set forth herein.

### BACKGROUND OF THE INVENTION

The present invention relates to a coated cogwheel and to a method for producing a coated cogwheel.

The following discussion of related art is provided to assist the reader in understanding the advantages of the invention, and is not to be construed as an admission that this related art is prior art to this invention.

Case hardening is a process used for hardening drive components and cogwheels to achieve a high degree of edge hardness and compressive stresses that counteract the wear and the failure modes due to Hertzian stress. Special coatings can further be applied to regions that are under pressure on cogwheels to further reduce wear. Practice has shown, however, that uneven loading of coated cogwheels can cause a coating of such kind to flake off, as a result of which the cogwheels' life span is very limited.

It would be desirable and advantageous to provide an improved coated cogwheel to obviate prior art shortcomings.

### SUMMARY OF THE INVENTION

According to one aspect of the present invention, a coated cogwheel includes a cogwheel body made from a basis material having a hardness, a layer arranged at least on a part of the cogwheel body and having a hardness which is greater than the hardness of the basis material, said layer being subdivided by seams into in a multiplicity of segments in spaced-apart relationship.

According to another aspect of the present invention, a method for producing a coated cogwheel includes the steps of arranging a layer of a first hardness on at least a part of a cogwheel body made from a basis material of a second hardness, with the first hardness being greater than the second hardness, and subdividing the layer by seams into a multiplicity of segments in spaced-apart relationship

A load in real applications is virtually never distributed evenly over a cogwheel's region under load, in particular a tooth flank, owing to shaft tilting, for instance, or compliance exhibited by a housing. Nor can such inhomogeneities always be suppressed by corrections because corrections are always optimal only for a specific load. The region under load, for example the tooth flank, therefore has to additionally adjust to and balance out the uneven loading by way either of elastic deformation or of running-in wear. As both mechanisms are difficult to implement in the case of layers protecting against wear that are conventionally embodied as being totally closed, the result has frequently been that the layers protecting against wear flake off. That disadvantage is avoided thanks to the inventive segmenting of the layer protecting against wear.

The invention is based on the knowledge that segmenting a relatively hard layer applied in the case of a cogwheel to a cogwheel body made from a softer basis material to provide protection from wear enables the two advantageous properties “rigidity” and “flexibility” to be distributed over different surface levels of the cogwheel. The terms “layer”, “coating” and “layer protecting against wear” are employed synonymously below.

The segmented layer offers protection against wear due to its hardness while the seams between the segments enable them to individually align themselves while under a load. Uneven loading of the coated cogwheel can in that way be balanced out better than if there were no segmenting so that the coating is prevented from flaking. The overall result is an improved property profile with reference to cogwheel loading because on the one hand protection against wear is provided owing to the hard surface layer and on the other hand a measure of flexibility and compliance is provided owing to the layer's being subdivided into separate segments. The cogwheel is hence in its coated regions able to combine two properties otherwise regarded more as being contrary.

Compared with continuous, i.e. closed coatings that often prove inflexible under a load, more even load distributing across a cogwheel's surface, in particular the surface of a tooth flank, is made possible by the present invention. That improves the protection against wear.

According to another advantageous feature of the present invention, the layer can form a surface of the coated cogwheel. The layer that serves as a protection against wear and is harder and usually also less flexible than the basis material from which the cogwheel body is made can therefore form an outer surface of the cogwheel. The layer can consequently function optimally as a layer protecting against wear.

According to another advantageous feature of the present invention, the layer can be arranged on at least one tooth flank of the cogwheel body. A tooth flank is normally the region on a cogwheel that is especially subject to loading and hence to wear. It is even possible for the segmented layer to be arranged exclusively on the cogwheel body's tooth flanks. For example the necessary elasticity in the region of the tooth base is in that way not adversely affected.

To increase the load capacity of tooth systems they are furnished with a coating that is not formed as being continuous or, as the case may be, closed but is segmented. Formed between adjoining segments are seams that are not furnished with a coating. According to another advantageous feature of the present invention, the layer is completely cut through by the seams. The layer's individual segments are in that way totally separate from each other and hence able to align themselves mutually totally independently. Stresses in the coating are largely obviated thereby and the layer hence prevented from flaking.

According to another advantageous feature of the present invention, the seams can be sized to extend into the cogwheel body. That means that advantageously also the basis material to which the coating is applied is cut into in the region of the seams. In that way a cogwheel surface, for example a tooth flank, is created having a plurality of plateaus exhibiting different hardness.

The effect of segmenting can thus be intensified by “cutting into” not only the layer but also a region of the basis material close to the surface. The result is thus a loading region of the cogwheel, for example a tooth flank, which region has plateaus exhibiting different hardness and suitably also different elasticity. The top region of the plateaus is strengthened by the hard layer and the plateaus are mutually separated by seams or grooves. The depth of the seams is to be selected such that the plateaus can align themselves flexibly in keeping with the load situation on a counter flank. The basis material's being cut into intensifies the advantageous combination of the properties “rigidity” and “flexibility” because the seams provide room for the lateral expansion occurring under a compressive stress and hence the compliance of the layer protecting against wear is being reduced.

According to another advantageous feature of the present invention, the seams can have a width sufficient to leave room for a lateral expansion occurring when the coated cogwheel is subjected to a pressure load. Seams having a sufficient width intensify the advantageous combination of the properties “rigidity” and “flexibility” because the seams provides room for the lateral expansion occurring under a compressive stress and hence the compliance of the layer protecting against wear is reduced. The shape of coated regions and the size of non-coated regions can be best suited to other boundary conditions. Any shape is basically possible. The type of layer is also freely selectable because the method is basically suitable for all layer types.

The segments can be formed by cutting into an originally closed coating or by covering the subsequent seams with a mask then applying the coating and finally removing the mask.

According to another advantageous feature of the present invention, the layer can be arranged on at least a part of the cogwheel body by covering the seam regions with a mask; applying the layer to non-covered regions of the cogwheel body; and removing the mask. The layer can be applied directly segmented by, for example, masking the intermediate regions with a structure so that the basis material remains uncoated there.

As an alternative, the layer can be arranged on at least a part of the cogwheel body by applying a closed layer to the cogwheel body; and segmenting the closed layer by forming the seams. The layer is thus first applied closed and then divided into the individual segments.

According to another advantageous feature of the present invention, the seams can be formed using a laser beam. Other methods, for example mechanical, chemical, or electric removal, are, of course, also possible.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a cogwheel body;

FIG. 2 is a perspective view of a coated tooth flank;

FIG. 3 shows a segmented layer;

FIGS. 4-6 are sectional views of steps of a first embodiment of a production method for producing a coated cogwheel;

FIGS. 7-8 are sectional views of steps of a second embodiment of a production method for producing a coated cogwheel; and

FIG. 9 is a section through a coated tooth flank having seams extending into the cogwheel body.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

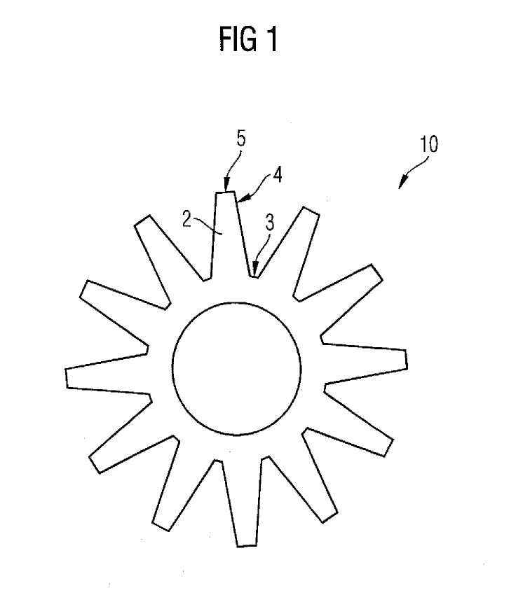

Turning now to the drawing, and in particular to FIG. 1, there is shown a schematic illustration of a cogwheel body, generally designated by reference numeral 10 and intended for coating. The cogwheel body 10 is made from a basis material, for example tempered steel such as 16MnCr5 or 18CrNiMo7-6. Arranged around the outer circumference of cogwheel body 10 are teeth 2 each having a tooth base 3, a tooth flank 4, and a tooth head 5.

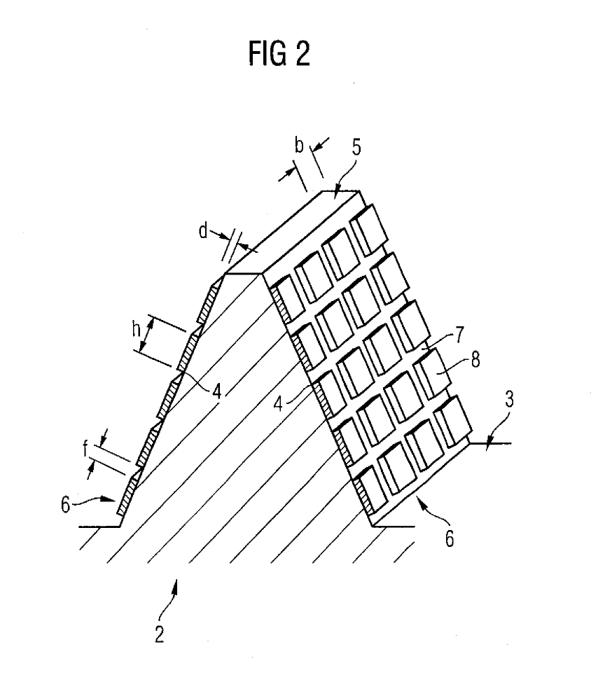

FIG. 2 is a perspective view of a tooth 2 of cogwheel body 10 shown in FIG. 1. Arranged on both flanks 4 of tooth 2 is a layer 6 which is harder than the basis material of cogwheel body 10 so as to be able to reduce wear on tooth flanks 4. The layer 6 has a thickness d and is not embodied as closed across tooth flank 4 but is subdivided into a multiplicity of segments 8. Two adjacent segments 8 are mutually separated by a seam 7 having a seam width f. The segments 8 are each defined by a width b and a height h. Tooth base 3 and tooth head 5 have been kept free from coating 6 in order not to limit elasticity in those regions.

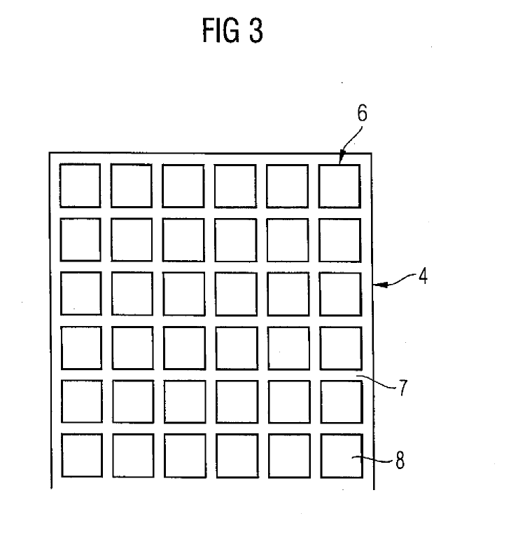

FIG. 3 is a front view of tooth flank 4 shown in FIG. 2. The layer 6 arranged on tooth flank 4 is formed not as being continuous but as segmented. Formed between adjoining segments 8 are seams 7 that have no coating.

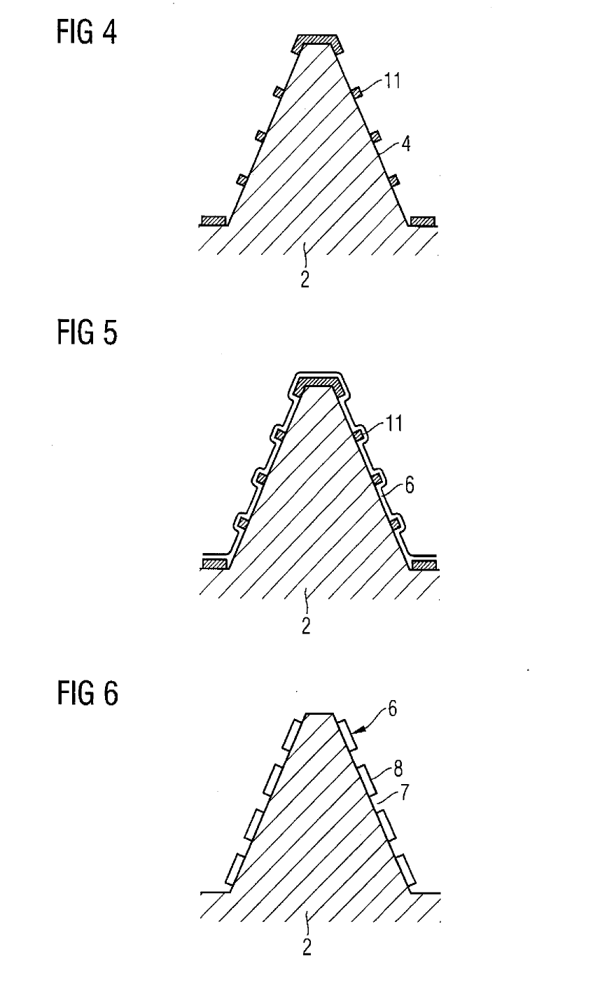

FIGS. 4 to 6 show a first exemplary embodiment of a production method according to the present invention.

FIG. 4 is a section through a tooth 2 of a cogwheel body 10. In a first step of the method, a mask 11 is applied to tooth flanks 4 in regions in which seams 7 are provided. Masking of such kind can be provided by, for example, applying a preferably water-soluble or solvent-soluble coat of lacquer 11 or by covering the seam regions 7 by covering elements (not shown).

In a second step, shown in FIG. 5, the tooth flanks 4 are coated with a friction-reducing and wear-reducing coating material such as, for example, Diamond-Like Carbon (=DLC) or TiN for embodying a layer protecting against wear. The coating material can be applied across all of tooth flank 4, i.e. both to masked regions 11 and to the non-masked regions. The layer protecting against wear in the sections between masked regions 11 is, in reality, of course far less thick than shown in FIG. 5.

The mask 11 applied to the tooth flanks 4 is removed in a third step, shown in FIG. 6. Coating material that was applied to the mask 11 is also removed along with masking layer 11. The end result is that layer 6 is present in the form of a multiplicity of mutually separated segments 8. A masking layer 11 embodied as a coat of lacquer can be removed by chemical etching, by washing, or mechanically, for example with the aid of a water jet or by brushing.

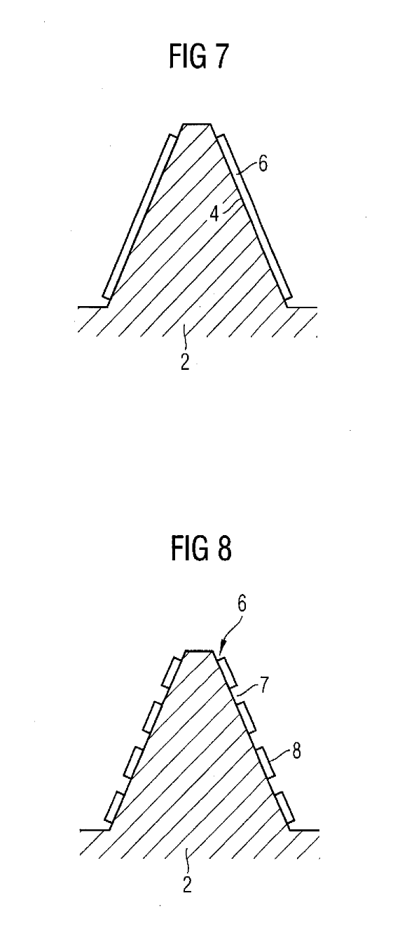

FIGS. 7 and 8 show another exemplary embodiment of a production method according to the present invention.

FIG. 7 is a section through a tooth 2 of a cogwheel body 10. In a first step of the method, tooth flanks 4 are coated with a friction-reducing and wear-reducing coating material such as, for example, Diamond-Like Carbon (=DLC) or TiN as a layer 6 formed as being continuous or closed for embodying a layer protecting against wear.

In a second step, shown in FIG. 8, the seams 7 are formed within continuous, i.e. uninterrupted or closed layer 6, as a result of which continuous layer 6 is subdivided into segments 8. Seams 7 can be formed by a laser beam or by mechanical removal, for example using a gouge. It is also possible for the seams to be formed using a known chemical masking method.

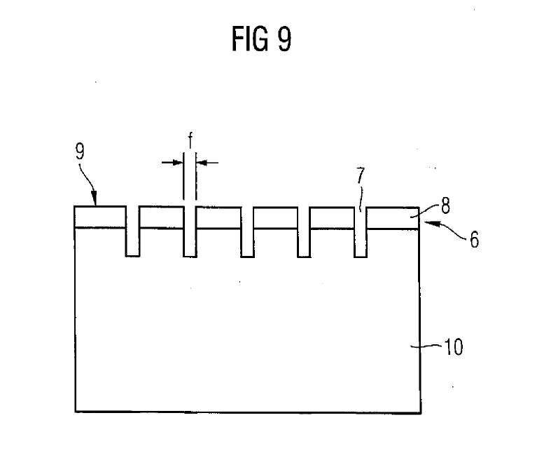

FIG. 9 is a section through cogwheel body 10 that is made from a basis material and having a surface 9 which is formed by a layer 6 applied to the cogwheel body 10. The layer 6 is subdivided into separate segments 8 by seams 7 extending into the cogwheel body 10. The layer 6 is thus embodied such as to be comprised of many individual layer regions 8 situated like tiles spaced at a distance f from one another on the basis material, for example a tooth flank.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A coated cogwheel, comprising:
a cogwheel body made from a basis material having a hardness;
a layer arranged at least on a part of the cogwheel body and having a hardness which is greater than the hardness of the basis material, said layer being subdivided by seams into in a multiplicity of segments in spaced-apart relationship.

2. The coated cogwheel of claim 1, wherein the layer forms a surface of the coated cogwheel.

3. The coated cogwheel of claim 1, wherein the layer is arranged on at least one tooth flank of the cogwheel body.

4. The coated cogwheel of claim 1, wherein the seams are sized to cut completely through the layer.

5. The coated cogwheel of claim 1, wherein the seams are sized to extend into the cogwheel body.

6. The coated cogwheel of claim 1, wherein the seams have a width sufficient wide to leave room for a lateral expansion when the coated cogwheel is subjected to a pressure load.

7. A method for producing a coated cogwheel, comprising the steps of:
arranging a layer of a first hardness on at least a part of a cogwheel body made from a basis material of a second hardness, with the first hardness being greater than the second hardness; and
subdividing the layer by seams into a multiplicity of segments in spaced-apart relationship.

8. The method of claim 7, wherein the arranging step includes covering a region of the seams with a mask, applying the layer to non-covered regions of the cogwheel body, and removing the mask.

9. The method of claim 7, wherein the arranging step includes applying a closed layer to the cogwheel body, and segmenting the closed layer by forming the seams.

10. The method of claim 9, the seams are formed using a laser beam.
